(19) United States
(12) Patent Application Publication
(10) Pub. No.: US 2007/0204951 A1
(43) Pub. Date: Sep. 6, 2007

(54) Method for applying a decorative laminate to a target surface

(75) Inventors: Mark John Steinhardt, Cincinnati, OH (US); Michael Bernard Dugas, Wyoming, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/712,189

(22) Filed: Feb. 28, 2007

Related U.S. Application Data
(60) Provisional application No. 60/778,832, filed on Mar. 3, 2006.

(51) Int. Cl. B32B 37/00

(52) U.S. Cl. 156/184; 156/217; 156/289

(57) ABSTRACT

A method provides instructions for the butt seam application of a surface covering laminate material. A quantity of a surface covering laminate is provided. A portion of the quantity comprises a web material having a first side and a second side. The first side comprises an adhesive. The second side is releasably joined to a release liner material. The first side of a first portion of the surface covering laminate is disposed in contact with a target surface. The first side of a second portion is disposed in contact with the target surface. At least a part of the second portion overlaps a part of the release liner of the first portion. The release liner is removed from the second portion. The release liner is removed from the first portion of the surface covering laminate together with that part of the second portion which overlaps the first portion.

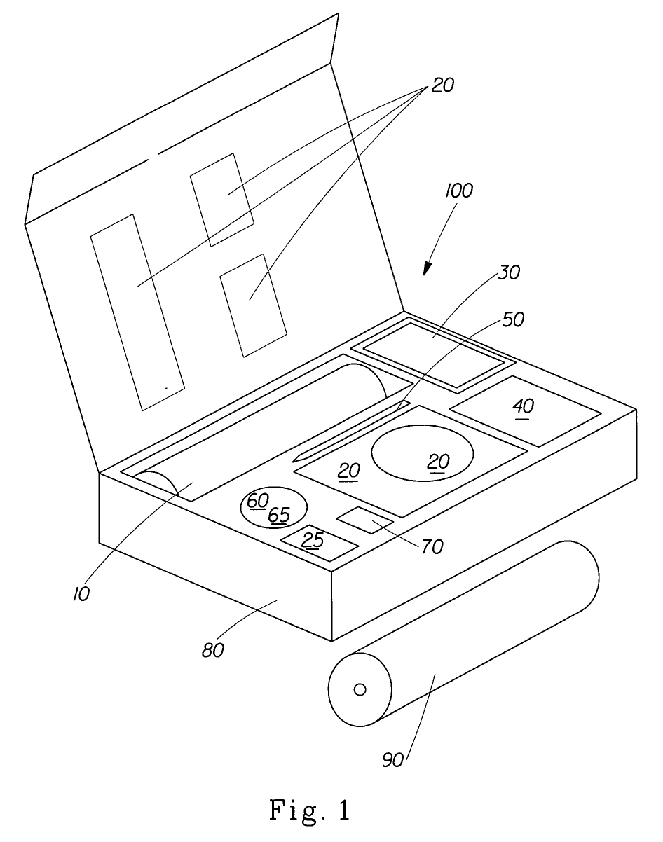

### CROSS REFERENCE TO RELATED APPLICATION

This application claims the benefit of U.S. Provisional Application 60/778,832, filed Mar. 3, 2006, which application is hereby incorporated herein by reference.

### FIELD OF THE INVENTION

The present invention relates to methods for applying a decorative laminate to a target surface. The invention relates particularly to a butt seaming method for applying a decorative laminate to a target surface. The method relates particularly to applying a decorative laminate to an architectural surface.

### BACKGROUND OF THE INVENTION

Decorative surface coverings are well known in the art. Wallpaper, and dry color laminates are generally known to be available in the form of a rolled web which may be unrolled and applied to a target surface, be it a wall, ceiling, floor or other surface. Dry color laminate materials comprising an adhesive layer and in some cases a release liner are known, but are not in wide use. The tools and methodologies for the efficient and aesthetic application of such materials are also not widely available.

The application of dry paint and other laminates may benefit from butt seams. Butt seams provide a smoother finished surface as there is no dual thickness area at the seams between material portions.

### SUMMARY OF THE INVENTION

In one aspect, a method provides steps for the butt seamed application of a surface covering material to a target surface. A quantity of a surface covering laminate is provided. At least a portion of the quantity comprises a web material having a first side and a second side wherein the first side comprises an adhesive and wherein the second side is releasably joined to a release liner material. The first side of a first portion of the surface covering laminate is disposed in contact with a surface to be covered. The first side of a second portion of the surface covering laminate is disposed in contact with the surface to be covered such that at least a part of the second portion overlaps a part of the release liner of the first portion. The release liner is removed from the second portion of the surface covering laminate. The release liner is removed from the first portion of the surface covering laminate together with that part of the second portion which overlaps the first portion.

In another aspect, the method comprises providing a quantity of a surface covering laminate material. The quantity may be separated into discrete portions either manually or by using a laminate applicator. At least one portion of the surface covering laminate comprises a web material having a first side and a second side wherein the first side comprises an adhesive and wherein the second side is releasably joined to a release liner material or backing sheet material. The first side of a first portion of the surface covering laminate is disposed in contact with a surface to be covered. The first side of a second portion of the surface covering laminate is disposed in contact with the surface to be covered and at least a part of the second portion overlaps a part of the release liner of the first portion. The release liner is removed from the first portion of the surface covering laminate material together with that part of the second portion, including the second portion release liner, which overlaps the first portion. This leaves the second portion adjacent and abutted to the first portion.

### BRIEF DESCRIPTION OF THE DRAWINGS

While the claims hereof particularly point out and distinctly claim the subject matter of the present invention, it is believed the invention will be better understood in view of the following detailed description of the invention taken in conjunction with the accompanying drawings in which corresponding features of the several views are identically designated and in which:

FIGURE schematically illustrates a perspective view of a kit according to one embodiment of the invention.

### DETAILED DESCRIPTION OF THE INVENTION

As shown in the FIGURE in one embodiment, a kit 100 for applying a surface covering material comprises a first applicator 10 adapted to hold a roll of surface covering material and to apply the surface covering material to a target surface. The kit 100 also comprises instructions 20 for the application of the surface covering material and for the use of the first applicator 10.

The first applicator 10 holds a roll of surface covering material and enables the application of the material to a target surface. The first applicator 10 may include, but is not limited to, features to facilitate the alignment, overlapping and severing of the surface covering material portions as the portions are applied to the target surface. The first applicator 10 is adapted to be used with rolls having a particular width or a width within a particular range of widths. The first applicator 10 may comprise indicia to provide guidance to a user in the sequence of operations to be performed in the use of the first applicator. Such indicia may be in the form of viewing angle dependent graphics such that the user will see varying indicia relating to particular steps of use depending upon the angle the indicia is viewed at. Such viewing angle dependent graphics may enable the communication of additional information to the user regarding the proper placement and use of the first applicator 10.

In one embodiment the first applicator comprises a series of smart dots which guide the user sequentially through the proper use of the first applicator 10 by the sequential illumination of respective dots according to input received in the use of the first applicator 10. Exemplary first applicators 10 are described in U.S. Pat. No. 6,808,586, issued Oct. 26, 2004 to Steinhardt, and pending US patent publication 2005/0092420, published May 5, 2005.

The surface covering material may comprise any surface covering material available in a roll form and adapted for application from the first applicator 10. Exemplary surface covering materials include dry paint as disclosed in co-pending US applications 2003/0134114A1, published Jul. 17, 2003; 2004/0076788, published Apr. 22, 2004; 2004/0200564, published Oct. 14, 2004; 2004/0253421A1, published Dec. 16, 2004; and 2005/0003129, published Jan. 6, 2005; 2005/0196607, published Sep. 8, 2005; and WIPO publications 2005/087492, published Sep. 22, 2005; 2005/087490, published Sep. 22, 2005; 2004/074003, published Sep. 2, 2004; and 2004/074009, published Sep. 2, 2004.

Exemplary instructions 20 include, but are not limited to, methods for preparing the target surface, applying the surface covering material to a target surface, applying the material to problematic areas of a target surface such as inside corners, outside corners, and curved surfaces, and dealing with items such as electrical outlets, thermostats, and switches. The instructions 20 may also provide a description of, and instructions for the use of any and all implements provided in the kit 100 for the application of the surface covering material to a target surface.

In one embodiment the breadth of the instructions includes a “Quick Start” instruction set limited to a basic set of instructions presented in a manner to allow a user to proceed rapidly to the actual application of the product without perusing more detailed instructions.

In one embodiment the instructions 20 include highly detailed and more complex “Professional Level” instructions to allow a consumer to achieve a more polished appearance with the surface covering material by following instructions requiring a higher level of application skill.

In one embodiment the instructions 20 include methods and tips for achieving a unique appearance using the surface covering material. Exemplary tips include the use of the material as an accent on surface, combining different colors and patterns of the material, using the material in combination with stencils or decals to achieve a more personalized appearance, and combinations of these methods.

The instructions 20 may be in any form suited to the nature of the content to be communicated. Exemplary instruction forms include, without being limited, printed text and/or images on the surface of the packaging of the kit 100, a printed booklet providing textual and/or graphic instruction in the use off the kit contents and the application of the surface covering material, digital storage media such as Digital Versatile Disks, Compact Disks, Compact Flash memory, or other digital storage means as are known in the art. The instruction may also be provided in an analog format such as video tape.

The instructions 20 may comprise audio and/or video presentations of the steps associated with the application of the surface covering material. The presentations may include step by step application instructions provided in an audio format suitable for playing via personal audio equipment. The presentation may be organized to enable a listener to listen to a step, pause the presentation, perform the step, and then resume the presentation. In one embodiment the presentation may be provided as an MP3 file suitable for playback via a personal MP3 player. In other embodiments the presentation may be reviewable using audio and video playback equipment as is known in the art.

In one embodiment the instructions 20 comprise a media presentation wherein the steps of a method are described and the listener is talked through the process. In this embodiment, the presentation includes auditory cues that are part of the process and provides reproductions of the actual auditory cues so as to better inform the listener with regard to what the cue associated with a particular step should sound like. The presentation may also comprise visual representations of what following the steps of the method to any particular point in the process should have yielded from a visual perspective.

Exemplary instructions 20 include a data file comprising either auditory, video or audio and video content. This file may be provided on storage media as such media are known in the art, or may be made available via a network for access and/or downloading by a user. The file may be stored in a computer, transferred to other media or stored in a media player such as an MP3 player. The user may then proceed to review the file and may follow the instructions during the review. The file may provide a step of the instructions and then prompt the user to perform the step. The file may provide visual or audio cues to guide the user as to the proper execution of the step. The file may describe or show what should be happening during a particular step. The user may access the file in a number of ways. The file may be reviewed sequentially and without stopping. The file may be viewed piecemeal with stoppages at opportune times to proceed with the installation of the material. The file may be reviewed out of order with particular steps being played for review and other steps being skipped. The instructions may separated into specific chapters with each chapter relating a particular step or aspect of the instructions 20.

In one embodiment the instructions 20 comprise a method for applying the surface covering material to an inside corner formed at the junction of a first surface and a second surface. In this embodiment the method comprises the step of scribing a line on the first surface, substantially parallel to a portion of the junction of the first and second surfaces. The line is spaced from the junction an amount less than the width of a roll of the surface covering material. As an example, a line may be scribed upon a wall, parallel to the junction of the wall and a second wall and spaced from the junction by about 3.5 cm. Using surface covering material from a roll of material having a width of about 5 cm., a portion of the surface covering material is applied to the first surface between the line and the junction, one edge of the surface covering material is aligned with the line. A portion of surface covering material covers a portion of the second surface beyond the junction; about 1.5 cm. of material is applied beyond the junction to the second wall. The applied portion of material is smoothed to remove any wrinkles or trapped air in the portion applied to either the first or second wall. This process may be repeated until the entire wall junction has been covered. The portion of surface covering material may be applied to the second wall in an amount ranging from about 0.1 cm to about 2.5 cm. After the application of a portion of the surface covering material to the first surface and overlapping onto the second surface, a second portion of the surface covering material may be applied to the second surface. The second portion may be applied to overlap with the previously applied portion. The second portion may be applied entirely to the second surface or may be applied to partially overlap onto the first surface.

In one embodiment the instructions 20 comprise a method for the application of the surface covering material. In this embodiment the method includes the step of selecting a portion of the target surface that is substantially free of obstructions and corner areas. First portions of the surface covering material are applied at the junction of the target surface and a second surface. As an example, and without limiting the invention, a segment or a plurality of segments of a trim width roll of surface covering material may be used to cover a portion of the center of a wall of a room, at the point where the wall meets the ceiling, or ceiling trim woodwork. After applying the trim, second portions of the surface covering material are applied from the first portions, over the target surface to a desired surface covering termination point. In the example, material from a wide roll is applied with some overlap of the trim portion between the trim portion and the floor, floor junction woodwork, chair rail or other lower termination point for the surface covering.

The covering of the surface may proceed at intervals at the convenience of the installer. There is no wet edge or any need to maintain a wet edge or any need to proceed before the web material dries, as may be the case when installing wallpaper. The application of the material need not begin in an unobtrusive portion of the room. Instead the application may be started in the most open and visible portion of the area to be covered.

In one embodiment the instructions comprise a method or methods for applying the surface covering material such that adjacent portions of the surface covering material abut each other without an overlapped seam.

In one embodiment, the method comprises the step of providing a quantity of a surface covering laminate material. The quantity may be separated into discrete portions either manually or by using a laminate applicator. At least one portion of the surface covering laminate comprises a web material having a first side and a second side wherein the first side comprises an adhesive and wherein the second side is releasably joined to a release liner material or backing sheet material. The first side of a first portion of the surface covering laminate is disposed in contact with a surface to be covered. The first side of a second portion of the surface covering laminate is disposed in contact with the surface to be covered and at least a part of the second portion overlaps a part of the release liner of the first portion. The release liner is removed from the second portion of the surface covering laminate material. The release liner is removed from the first portion of the surface covering laminate material together with that part of the second portion which overlaps the first portion. This leaves the second portion adjacent and abutted to the first portion.

The removal of the backing sheet material or release liner may be facilitated by applying a portion of an adhesive backed backing sheet removal implement to an upper corner of the release liner and pulling downward at an angle of between about 15 and about 75 degrees from the long edge of the surface covering laminate. In an alternative embodiment the backing sheet may be removed by pulling at an angle of between about 30 and about 60 degrees from the long edge. The backing sheet removal implement may be affixed to each successive portion of surface covering laminate as the portion is affixed to the target surface. In one embodiment the instructions 20 include a card illustrating the use of the adhesive backed backing sheet removal implement.

The peel angle associated with the removal process is considered to be about 180 degrees since the material is being pulled off by a motion moving along the target surface away from the starting point. At the same time the material is being pulled at an angle of between about 15 and about 75 degrees from the long edge of the surface covering material.

In one embodiment the seaming method includes burnishing the second portion of material at the point of overlap with the first portion of material. Burnishing the material by passing a roller burnishing tool along the overlap point may improve the removal of the overlapped portion together with the backing sheet of the first portion. An exemplary burnishing tool is a Speedball Brayer, available from Speedball Art Products, of Statesville, N.C.

In one embodiment the method includes aligning an edge of an implement along the overlapped edge of the first portion prior to the removal of the release liner of the first portion to enhance the removal of material.

In one embodiment the method includes providing at least a first portion of surface covering laminate comprising a pull tab fixedly attached to the release liner and disposed to extend beyond the web material of the laminate sheet. In this embodiment there is no need to apply a backing sheet removal implement to the at least one portion.

In one embodiment the method includes providing a surface covering laminate portion wherein the release liner is more than coextensive with the web material. In this embodiment, the extra release liner may be used to begin the removal of the release liner as a whole and no additional backing sheet removal implement is needed.

In one embodiment the method includes providing at least one quantity of surface covering laminate material wound about itself in a substantially cylindrical form and having a length determined according to a dimension of the surface to be covered. In this embodiment, the surface covering laminate is prepared according to the dimensions of the target surface such that each roll of material is sized to cover a single width of area from edge to edge.

In one embodiment the method includes providing a surface covering laminate wherein the release liner comprises indicia disposed parallel to at least one edge of the material. In this embodiment, the release liner may be printed, embossed or otherwise marked with indicia to guide the installer as to where subsequent portions should be positioned to achieve the optimal overlapped portion. The indicia may be a continuous line or a segmented line. The indicia may assist in the alignment of subsequent portion with or without a covering applicator. The material may comprise indicia along a single edge or each edge to indicate the overlap point for subsequent portions applied along either edge.

In one embodiment, the method comprises the step of providing a quantity of a surface covering laminate material. The quantity may be separated into discrete portions either manually or by using a laminate applicator. At least one portion of the surface covering laminate comprises a web material having a first side and a second side wherein the first side comprises an adhesive and wherein the second side is releasably joined to a release liner material or backing sheet material. The first side of a first portion of the surface covering laminate is disposed in contact with a surface to be covered. The first side of a second portion of the surface covering laminate is disposed in contact with the surface to be covered and at least a part of the second portion overlaps a part of the release liner of the first portion. The release liner is removed from the first portion of the surface covering laminate material together with that part of the second portion, including the second portion release liner, which overlaps the first portion. This leaves the second portion adjacent and abutted to the first portion. Optionally, the release liner for the second portion may be scored along the overlap line to facilitate the shearing of the liner at that point during the removal process.

The removal of the backing sheet material or release liner may be facilitated by applying a portion of an adhesive backed backing sheet removal implement to an upper corner of the release liner and pulling downward at an angle of between about 15 and about 75 degrees from the long edge of the surface covering laminate. In an alternative embodiment the backing sheet may be removed by pulling at an angle of between about 30 and about 60 degrees from the long edge. The backing sheet removal implement may be affixed to each successive portion of surface covering laminate as the portion is affixed to the target surface. In one embodiment the instructions 20 include a card illustrating the use of the adhesive backed backing sheet removal implement.

The peel angle associated with the removal process is considered to be about 180 degrees since the material is being pulled off by a motion moving along the target surface away from the starting point. At the same time the material is being pulled at an angle of between about 15 and about 75 degrees from the long edge of the surface covering material.

In one embodiment the seaming method includes burnishing the second portion of material at the point of overlap with the first portion of material. Burnishing the material by passing a roller burnishing tool along the overlap point may improve the removal of the overlapped portion together with the backing sheet of the first portion. An exemplary burnishing tool is a Speedball Brayer, available from Speedball Art Products, of Statesville, N.C.

In one embodiment the method includes aligning an edge of an implement along the overlapped edge of the first portion prior to the removal of the release liner of the first portion to enhance the removal of material along the overlap point.

In one embodiment the method includes providing at least a first portion of surface covering laminate comprising a pull tab fixedly attached to the release liner and disposed to extend beyond the web material of the laminate portion. In this embodiment there is no need to apply a backing sheet removal implement to the at least one portion.

In one embodiment the method includes providing a surface covering laminate material wherein the release liner is more than coextensive with the web material. In this embodiment, the extra release liner may be used to begin the removal of the release liner as a whole and no additional backing sheet removal implement is needed.

In one embodiment the instructions include a method for applying a surface covering material that does not incorporate a backing sheet and for achieving a butt seam between adjacent portions of this material. This embodiment includes steps of applying a first portion of the material using an applicator that incorporates a folding board. The folding board applicator folds one edge of the material back during the application such that a predetermined amount of the material is not adhered to the target surface but is instead folded away from the surface. A second portion of the material is then applied overlapping the folded portion of the first material portion. The overlapped portions are then burnished at the junction with the target surface and removed either with or without the aid of an edged implement.

The method of applying the surface covering material utilizing a folding board applicator may also be practiced with a surface covering material comprising a release liner. The release liner of the second portion of surface covering material may be scored along the overlapped fold line prior to the removal of the release liner form the first portion of the material.

In one embodiment the method includes steps of providing a liner-less surface covering material and applying a first portion of the material to the target surface. A portion of the first material portion substantially parallel to one edge of the applied portion is then covered using an edge tool or with an adhesive edge covering implement. A second material portion is then applied to the target surface overlapping the edge tool or adhesive edge covering implement. The tool or adhesive implement is then removed together with the overlapped portion of the second material portion.

In one embodiment the method includes providing at least one quantity of surface covering laminate material wound about itself in a substantially cylindrical form and having a length determined according to a dimension of the surface to be covered. In this embodiment, the surface covering laminate is prepared according to the dimensions of the target surface such that each roll of material is sized to cover a single width of area from edge to edge. The length of material in any particular roll may be longer than the actual target surface portion to enable the installer to trim the ends of the material to suit their needs.

In one embodiment the method includes providing a surface covering laminate wherein the release liner comprises indicia disposed parallel to at least one edge of the material. In this embodiment, the release liner may be printed, embossed or otherwise marked with indicia to guide the installer as to where subsequent portions should be positioned to achieve the optimal overlapped portion. The indicia may be a continuous line or a segmented line. The indicia may assist in the alignment of subsequent portion with or without a covering applicator. The material may comprise indicia along a single edge or each edge to indicate the overlap point for subsequent portions applied along either edge.

Information relating to additional instructional sources may also be provided as part of the kit 100. Exemplary additional sources include, without being limiting, telephone contact numbers, internet web sites, mailing addresses, and order forms for additional instruction media. Provided internet sources may include access to content that may in turn be downloaded by a user for storage and playback at a later time or for printing for use during the application process.

In one embodiment the kit provides guidance regarding access to the services of professional installers to assist in part or all of the actual installation. In this embodiment, consumers who choose to forgo installing the surface covering material by themselves can easily explore the possibility of having the installation performed by a professional installer.

In one embodiment the kit 100 also comprises a reference card 25. The reference card 25 comprises a condensed version of the application instructions and may comprise a lanyard, clip, or other means of attachment to enable the installer to keep the reference card 25 at close proximity while proceeding with the surface covering application. The reference card 25 may comprise a set of keywords relating to the steps of the installation process, or a set of graphical images associated with the application steps. The reference card 25 may refer to indicia incorporated into the application implements provided in the kit to provide guidance to the user in the proper sequence of use of any particular implement. The reference card 25 may comprise a combination of text and graphics to prompt the user in the steps of the application method.

In one embodiment the kit 100 further comprises a second applicator 30 adapted to hold and facilitate the application of a second roll of the surface covering material to the target surface. The second applicator 30 is adapted to be used in the application of rolls of the surface covering material of a width that is substantially different from the width or range of widths of rolls associated with the first applicator 10. An exemplary second applicator is adapted to the application of a trim roll of the surface covering material. A trim roll is relatively narrow in comparison to the rolls associated with the first applicator 10. As an example, a roll configured for use with the first applicator may comprise a width in the range of about 25 to about 35 cm. In contrast a roll configured for use with the second applicator may comprise a width of about 4 to about 8 cm.

In an alternative embodiment, the second applicator serves as a dispenser and facilitates the dispensing of portions of the relatively narrow roll for manual application to the target surface.

In one embodiment the surface covering material may comprise a release liner and the second applicator, or dispenser, 30 may comprise a means for separating the release liner of the surface covering material from the remainder of the material. The means may comprise a tab or series of tabs configured to enable the surface covering material to be routed with the release liner positioned on one side of a tab and the remainder of the material on the other side of the tab. This configuration may facilitate the separation of the release liner as the surface covering material is dispensed from the second applicator 30.

In one embodiment the instructions 20 may include steps for facilitating the separation of the adhesive portion of the trim troll of surface covering material from the release liner of the roll. The steps may include routing a portion of the roll out of the dispenser or second applicator 30 and passing the portion under a separator tab. A portion of a backing sheet removal implement may be adhesively attached to the adhesive portion of the material, including being attached to the material along the tab edge and upstream of the tab. The subsequent removal of addition material from the dispenser may result in a separation of the adhesive portion from the backing sheet material along the tab edge.

The second applicator 30 may comprise visual cues to enable a user to load a roll of material 90 into the second applicator so as to properly separate the release liner during dispensing. The instructions 20 may include methods for the proper loading of the second applicator 30 and for the use of the second applicator 30 in the overall application of the surface covering material.

In one embodiment the kit 100 includes an instruction card 27 that provides instructions regarding separating the release liner material from the adhesive portion of the laminate material of the trim roll. The kit 100 may comprises one or more edge recovery cards 29 adapted to facilitate recovering the separation of the release liner form the remaining portion of the trim roll of the laminate material.

The kit 100 may further comprise an application refinement implement 40 adapted to facilitate the refining of the application of the surface covering material to the target surface. The application refinement implement may comprise a smoothing tool having a gripping surface and one or more smoothing edges adapted to facilitate the removal of wrinkles and/or air bubbles from portions of the surface covering material previously applied to a target surface.

In one embodiment the application refinement implement 40 comprises one or more alignment holes which may be used in conjunction with a scribing implement 50 to facilitate the application of the surface covering material in problematic areas such as corners. In this embodiment, the instructions 20 may provide a method for the use of the application refinement implement 40 together with a scribing implement 50 in the application of the surface covering material to problematic areas.

The kit 100 may further comprise scribing implement 50. Exemplary scribing implements include, without being limiting, awls, pens, and pencils. The scribing implement 50 may be configured to function cooperatively with the application refinement implement 40 in the scribing of lines upon the target surface to facilitate the application of the surface covering material.

In one embodiment the surface covering material includes a release liner or backing sheet material. In this embodiment the kit 100 may comprise a quantity of a backing sheet removal implement 60. The backing sheet removal implement 60 is adapted to adhesively attach to the backing sheet material. Such attachment enables the separation of the backing sheet material from the remainder of the surface covering material after the surface covering material and backing sheet have been applied to the target surface. The backing sheet removal implement 60 may be provided in the form of discrete portions, or in the form of a roll of backing sheet removal material. A dispenser 65 may be provided to facilitate the separation of a roll of backing sheet removal implement 60 into discrete portions. The instructions 20 may comprise steps for the efficient use of the backing sheet removal implement 60 during the application of the surface covering material.

In one embodiment the kit 100 comprises a reciprocating adhesive backing sheet removal tool. This tool comprises an adhesive surface that may be moved from a recessed position to an exposed position. In the recessed position, the likelihood of incidental contact between the adhesive surface and any other surface is substantially reduced. In this embodiment, the tool is placed adjacent to the backing sheet of an applied portion of the surface covering material and the adhesive surface is moved to the exposed position such that the adhesive contacts the backing sheet. The adhesive is then moved to the recessed position pulling at least a portion of the backing sheet away from the remainder of the surface covering material.

The kit 100 may further comprise at least one cleaning implement 70 adapted to clean at least a portion of the first applicator 10 to maintain or restore optimal applicator performance. The application of the surface covering material using the first applicator 10 may be degraded over time as dust, debris or other material collects upon a portion, or portions, of the first applicator 10. Degradation in the performance of the first applicator 10 may be attributed to the quality of the surface covering material and may adversely impact the overall consumer experience associated with the surface covering material. The maintenance or restoration of optimal applicator function may require that the affected portion, or portions, of the first applicator 10 be cleaned to remove any accumulated material. Providing an appropriate cleaning implement may encourage applicator cleaning and facilitate maintaining the first applicator at a level of performance closer to the optimal level thereby enhancing the consumer experience associated with the application of the surface covering material. Exemplary cleaning implements 70 include, without limitation, discrete packaged alcohol wipes as are known in the art, and an alcohol pen with a porous tip. The alcohol wipe or pen may be used to restore the performance of the applicator 10 to optimal or near optimal.

The kit 100 may further comprise a carton 80 adapted to hold all of the component implements of the kit 100. The carton 80 may be a simple container and may hold the other kit 100 implements in a loose fashion. In one embodiment the carton 80 is segmented and comprises tailored compartments, each compartment configured to hold a particular kit implement. As an example, the carton 80 may have tailored compartments for each of a first applicator 20, an instructional Digital Versatile Disk 20, an instructional booklet 20, a second applicator 30, an application refinement implement 40, a scribing implement 50, a quantity of backing sheet removal material 60, and a dispenser for the backing sheet removal material 65, a reference card 25 and Idea Books describing special application techniques. The carton 80 may comprise additional space configured for storing one or more rolls 90 of surface covering material configured for use with either the first applicator 10 or the second applicator 30. The carton 80 may comprise storage space for additional instructional materials. In one embodiment the kit 100 may comprise one or more rolls 90 of the surface covering material. In one embodiment the carton 80 may be unfolded to display and access all the kit 100 components, and may subsequently be folded to store all the components.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would have been obvious to those skilled in the art that various other changes and modifications can be made without departing from the spirit and scope of the invention. It is therefore intended to cover in the appended claims all such changes and modifications that are within the scope of the invention.

What is claimed is:

1. A method of covering a surface, the method comprising steps of:
a) providing a quantity of a surface covering laminate, at least a portion of the quantity comprising a web material having a first side and a second side wherein the first side comprises an adhesive and wherein the second side is releasably joined to a release liner material,
b) disposing the first side of a first portion of the surface covering laminate in contact with a surface to be covered,
c) disposing the first side of a second portion of the surface covering laminate in contact with the surface to be covered such that at least a part of the second portion overlaps a part of the release liner of the first portion,
d) removing the release liner from the second portion of the surface covering laminate,
e) removing the release liner from the first portion of the surface covering laminate together with that part of the second portion which overlaps the first portion.

2. The method according to claim 1 further comprising the step of:
burnishing the part of the second portion which overlaps the edge of the first portion.

3. The method according to claim 1 further comprising the step of:
aligning an edge of an implement along the overlapped edge of the first portion prior to the removal of the release liner of the first portion.

4. The method according to claim 1 comprising the step of:
pulling the release liner of the first portion in a direction substantially parallel to the covered surface and at an angle of between about 15 and about 75 degrees with respect to the overlapped edge of the first portion.

5. The method according to claim 1, wherein the step of providing a quantity of a surface covering laminate comprises providing at least a first sheet of surface covering laminate comprising a pull tab fixedly attached to the release liner and disposed to extend beyond the web material of the laminate sheet.

6. The method according to claim 5 wherein the step of removing the release liner of the first sheet comprises pulling the pull tab of the first sheet.

7. The method according to claim 1 wherein the step of providing a quantity of a surface covering laminate comprises providing a surface covering laminate sheet wherein the release liner is more than coextensive with the web material.

8. The method according to claim 1 wherein the step of providing a quantity of a surface covering laminate comprises providing at least one sheet wound about itself in a substantially cylindrical form and having a sheet length determined according to a dimension of the surface to be covered.

9. The method according to claim 1 wherein the step of providing a quantity of a surface covering laminate comprises providing a surface covering laminate wherein the release liner comprises indicia disposed parallel to at least one edge of the laminate.

10. A method of covering a surface, the method comprising steps of:
a) providing a quantity of a surface covering laminate, at least one portion of the laminate comprising a web material having a first side and a second side wherein the first side comprises an adhesive and wherein the second side is releasably joined to a release liner material,
b) disposing the first side of a first portion of the surface covering laminate in contact with a surface to be covered,
c) placing the first side of a second portion of the surface covering laminate in contact with the surface to be covered such that at least a part of the second portion overlaps a part of the first portion,
d) removing the release liner from the first portion of the surface covering laminate,
wherein a part of the second portion of the surface covering laminate including a part of the surface covering material and a portion of the release liner are removed concurrently with the release liner of the first portion.

11. The method according to claim 10 further comprising the step of:
burnishing the part of the second portion which overlaps the edge of the first portion.

12. The method according to claim 10 further comprising the step of:
aligning an edge of an implement along the overlapped edge of the first portion prior to the removal of the release liner of the first portion.

13. The method according to claim 10 comprising the step of:
pulling the release liner of the first portion in a direction substantially parallel to the covered surface and at an angle of between about 15 and about 75 degrees with respect to the overlapped edge of the first portion.

14. The method according to claim 10, wherein the step of providing a quantity of a surface covering laminate comprises providing at least a first portion of surface covering laminate comprising a pull tab fixedly attached to the release liner and disposed to extend beyond the web material of the laminate portion.

15. The method according to claim 14 wherein the step of removing the release liner of the first portion comprises pulling the pull tab of the first portion.

16. The method according to claim 10 wherein the step of providing a quantity of a surface covering laminate comprises providing a surface covering laminate sheet wherein the release liner is more than coextensive with the web material.

17. The method according to claim 10 wherein the step of providing a quantity of a surface covering laminate comprises providing at least one sheet wound about itself in a substantially cylindrical form and having a sheet length determined according to a dimension of the surface to be covered.

18. The method according to claim 10 wherein the step of providing a quantity of a surface covering laminate comprises providing a surface covering laminate wherein the release liner comprises indicia disposed parallel to at least one edge of the laminate.

19. A method of marketing a surface covering laminate, the method comprising steps of:
a) providing a quantity of a surface covering laminate,
b) providing a method for applying the laminate to a surface to be covered, wherein the method discloses a process adapted to abut successive portions of the laminate.

20. The method according to claim 19 wherein the step of providing a quantity of a surface covering laminate comprises providing at least one sheet of laminate wound about itself and having a length associated with a dimension of the surface to be covered.
